(19) United States
(12) Patent Application Publication
(10) Pub. No.: US 2018/0314330 A1
(43) Pub. Date: Nov. 1, 2018

(54) HAPTIC DEVICE LINKED WITH AUGMENTED REALITY OR VIRTUAL REALITY IMPLEMENTATION DEVICE

(71) Applicant: RBK EMD CO., LTD., Anyang-si, Gyeonggi-do (KR)

(72) Inventors: Jae Wook RYU, Seoul (KR); He Won JUNG, Ansan-si, Gyeonggi-do (KR)

(21) Appl. No.: 15/779,359

(22) PCT Filed: Jun. 14, 2017
(86) PCT No.: PCT/KR2017/006170

§ 371 Date: May 25, 2018

(30) Foreign Application Priority Data
Aug. 16, 2016 (KR) 10-2016-0103400

(51) Int. Cl. G06F 3/01; G06F 3/0346

(52) U.S. Cl. CPC G06F 3/016; G06F 3/0346; G06F 3/011

(57) ABSTRACT

Provided is a haptic device linked with an augmented reality or virtual reality implementation device, and more particularly, to a haptic device linked with an augmented reality or virtual reality implementation device, the device being capable of causing an environmental change in augmented reality or virtual reality through a specific operation and being capable of providing a vibration signal to a user according to an environmental change in the augmented reality or virtual reality. The haptic device linked with the augmented reality or virtual reality implementation device can include a main body held by a user; a sensor unit provided in the main body and sensing the position, posture, or operation of the main body; a communication unit, provided in the main body, for communicating with the augmented reality or virtual reality implementation device; and a vibration unit provided in the main body and vibrating the main body.

### TECHNICAL FIELD

The present invention relates to a haptic device linked with an augmented reality or virtual reality implementation device, and more particularly, to a haptic device linked with an augmented reality or virtual reality implementation device, which may cause a change of an environment in an augmented reality or a virtual reality with a specific operation and may provide a vibration signal to the user according to the change of the environment in the augmented reality or the virtual reality.

### BACKGROUND ART

An augmented reality (AR) may focus on a combination of a reality world and computer generated data by mixing augmented information that is to be displayed to the user in real time and a scene of the reality world. The range of the AR is expanding to wide application areas such as advertising, navigation, and entertainments.

In the augmented reality (AR) environment, the user may integrate artificial or virtual graphics with actual natural environments around the user such that the user may view the integrated graphics. For example, the user may view graphics arbitrarily displayed in actual natural environments around the user through augmented reality goggles and the like.

However, the general augmented reality (AR) provides an augmented reality that depends on the vision of the user through goggles or an electronic device equipped with a screen. Accordingly, the conventional augmented reality decreases the immersion of the user, and there is a limit in utilizing various augmented reality contents.

### PRIOR TECHNICAL DOCUMENTS

(Patent Document 1) Korean Patent Application Publication No. 10-2016-0068827 (Jun. 15, 2016)

(Patent Document 2) Korean Patent Application Publication No. 10-2016-0068837 (Jun. 15, 2016)

### DISCLOSURE

### Technical Problem

The present invention has been made in an effort to solve the above-mentioned problems, and provides a haptic device linked with an augmented reality or virtual reality implementation device, which may cause a change of an environment in an augmented reality or a virtual reality with a specific operation and may provide a vibration signal to the user according to the change of the environment in the augmented reality or the virtual reality.

### Technical Solution

In accordance with an aspect of the present invention, there is provided a haptic device linked with an augmented reality or virtual reality implementation device including a body that is gripped by a user, a sensor unit installed in the body and configured to detect a location, a posture, or an operation of the body, a communication unit installed in the body and configured to communicate with the augmented reality or virtual reality implementation device, and a vibration unit installed in the body and configured to generate vibration in the body.

The communication unit receives a reception signal from the device according to a change of an environment in an augmented reality or a virtual reality realized by the device, and the vibration unit generates vibration in the body if receiving the reception signal.

The reception signal is any one of a plurality of different signals, and the vibration unit generates different vibrations, one or more of the magnitudes and cycles of which are different according to the reception signal.

The haptic device further includes a controller installed in the body and configured to operate the communication unit and the vibration unit, and the operation is stored in the controller in advance, the sensor unit detects a change of a location of the body or an implementation of the operation, and the communication unit delivers a transmission signal according to the change of the location of the body or the implementation of the operation to the device.

The environment in the augmented reality or the virtual reality changes according to the transmission signal delivered from the communication unit to the device, and the communication unit receives a reception signal from the device according to the change of the environment in the augmented reality or the virtual reality.

The operation is any one of a linear motion, a parabolic motion, a circular motion, and a rotation.

The vibration unit generates vibrations, one or more of magnitudes and cycles of which is different according to the operation.

The sensor unit includes any one of an acceleration sensor, a gyro sensor, and a geomagnetic sensor.

### Advantageous Effects

The haptic device linked with an augmented reality or virtual reality implementation device according to the present invention may cause a change of an environment in an augmented reality or a virtual reality with a specific operation and may provide a vibration signal to the user according to the change of the environment in the augmented reality or the virtual reality, there by doubling the immersion of the augmented reality or the virtual reality that is felt by the user.

### DESCRIPTION OF THE DRAWINGS

FIG. 1 is a view schematically illustrating an augmented reality or virtual reality implementation device and a haptic device linked with the augmented reality or virtual reality implementation device according to an embodiment of the present invention;

FIG. 2 is a view schematically illustrating an usage of an augmented reality or virtual reality implementation device and a haptic device linked with the augmented reality or virtual reality implementation device according to an embodiment of the present invention; and

FIG. 3 is a view exemplifying an operation form that is realized by a haptic device according an embodiment of the present invention.

### DESCRIPTION OF REFERENCE NUMERALS

100: Haptic device
10: Body
20: Sensor unit
30: Communication unit
40: Vibration unit
50: Controller
200: AR/VR device

### BEST MODE

### [Mode]

The present invention relates to a haptic device linked with an augmented reality or virtual reality implementation device, which may cause a change of an environment in an augmented reality or a virtual reality with a specific operation and may provide a vibration signal to the user according to the change of the environment in the augmented reality or the virtual reality. The device that realizes an augmented reality or a virtual realty may be a portable terminal such as a smartphone, an augmented reality or virtual reality dedicated device, and various smart wearable devices.

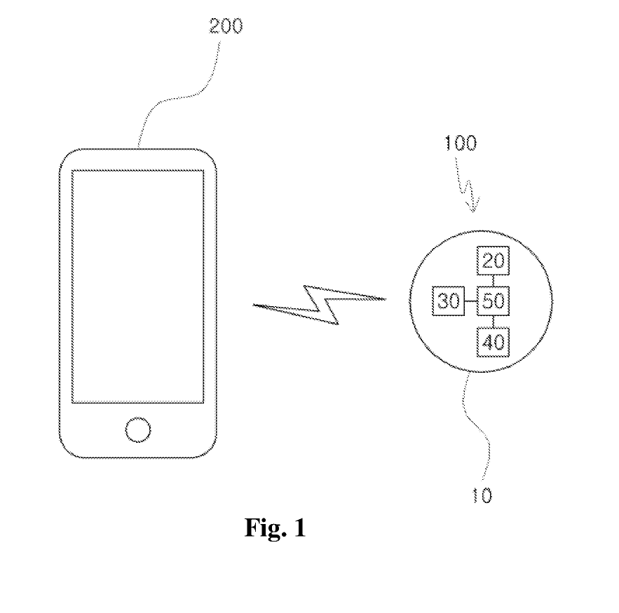

As illustrated in FIGS. 1 to 3, a haptic device 100 linked with an augmented realty or virtual reality implementation device according to an embodiment of the present invention includes a body 10, a sensor unit 20, a communication unit 30, a vibration unit 40, and a controller 50.

The body 10 has a substantially spherical shape, and has an accommodation space in the interior thereof. The body has a size by which the user may carry the haptic device 100 while gripping the haptic device 100 with one hand. The body has a size by which the user may carry the haptic device 100 while gripping the haptic device 100 with one hand. The body 10 may include a battery (not illustrated) for supplying electric power to the sensor unit 20, the communication unit 30, the vibration unit 40, and the controller 50. The body 10 may opened and closed.

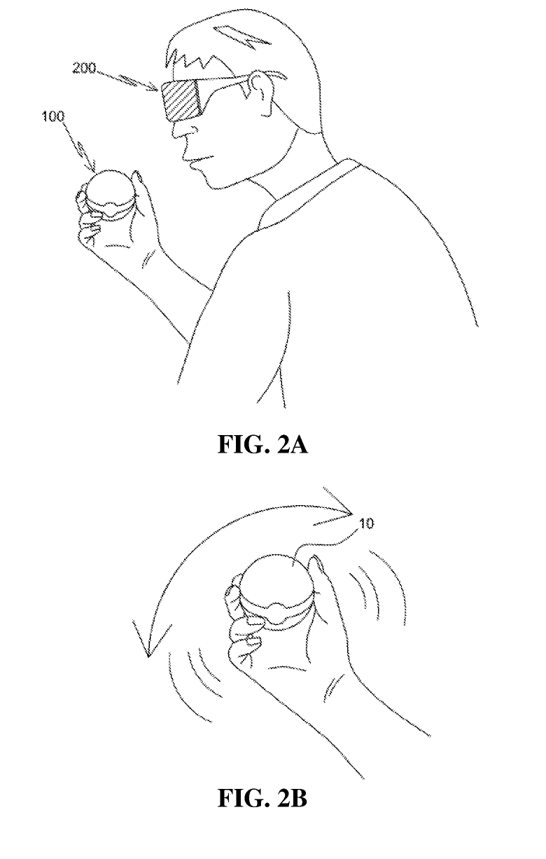

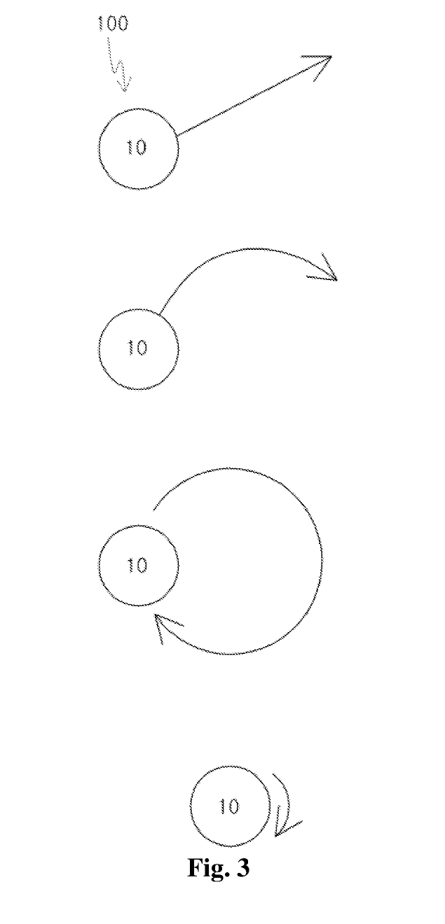

The sensor unit 20 is installed in the interior of the body 10 and detects a location or an operation of the body 10. The operations that may be realized by using the body 10 are stored in the controller 50. In detail, the change of the location of the body 10 may be a change of a vertical location or a horizontal location of the body 10, and a change of a posture of the body 10, such as rotation of the body 10, and as illustrated in FIG. 2, the change of the location of the body 10, the change of the posture of the body 10, and an implementation of an operation of the body 10 may be made by the user, in which case the implementation of the operation of the body 10 by the user may be any one of a linear motion, a parabolic motion, a circular motion, and a rotation as illustrated in FIG. 3. In order to detect a change of the location of the body 10, a change of the posture of the body 10, or the implementation of the operation of the body, the sensor unit 20 includes an acceleration sensor, a gyro sensor, and a geomagnetic sensor. Further, various sensors may be provided in addition to the above-described sensors.

The communication unit 30 is a device that is installed in the interior of the body 10 to communicate with an augmented reality or virtual reality implantation device (hereinafter, an AR/VR device 200). The communication unit 30 receives a reception signal from the AR/VR device 200 according to a change of an environment in an augmented reality or a virtual reality realized by the AR/VR device 200, or delivers a transmission signal to the AR/VR device 200 according to a change of a location of the body 10, a change of a posture of the body 10, or an implementation of an operation of the body 10. The communication unit 30 may use various communication units such as Bluetooth or Wi-Fi.

A change of an environment in an augmented reality or a virtual reality may be an occurrence of an event that is suitable for an augmented reality or a virtual reality or a success or a failure of attainment of a purpose or a target, and a reception signal may be any one of a plurality of signals corresponding to various changes of an environment in the augmented reality or the virtual reality. Further, a transmission signal is a signal corresponding to a change of a location of the body 10, a change of a posture of the body 10, or a specific operation of the body 10, which is detected by the sensor unit 20, and is delivered to the AR/VR device 200 through the communication unit 30 to cause a change of the environment in the augmented reality or the virtual reality.

The vibration unit 40 is installed in the interior of the body 10 to generate vibration in the body 10. In detail, the vibration unit 40 may generate vibration in the body 10 if receiving a reception signal from the AR/VR device 200 or may generate vibration in the body 10 according to a change of a location of the body 10, a change of a posture of the body 10, or an implementation of an operation of the body 10. The vibration unit 40 may use haptic actuators that are disclosed in Korean Patent Nos. 10-1434264 and 10-1583641 or may use vibration modules of various other forms.

First, if a reception signal is received from the AR/VR device 200 through the communication unit 30, vibration is generated in the body 10 so that an event occurs in the augmented reality or the virtual reality or information on a success or a failure of attainment of a purpose or a target is provided to the user. Further, the vibration unit 40 may generate vibrations, the magnitudes or cycles of which are different, according to various reception signals to allow the user to distinguish the vibrations, making it possible to recognize the types of the changes of the environment in the augmented reality or the virtual reality.

Further, the vibration unit 40 may generate vibrations, the magnitudes or cycles of which are different, according to an operation of the body 10 to provide a feedback signal such that the user may identify whether the operation of the body 10 is an intended operation.

The controller 50 is installed in the interior of the body 10 to operate the communication unit 30 and the vibration unit 40.

Next, a method for using a haptic device 100 linked with an augmented reality or virtual reality implementation device according to an embodiment of the present invention will be described.

The haptic device 100 according to the embodiment of the present invention is linked with an augmented reality or virtual reality implementation device, and if an event occurs in an augmented reality or a virtual reality or a success or a failure of attainment of a purpose or a target is determined, the AR/VR device 200 generates a reception signal corresponding to a specific environment changing situation, and if the communication unit 30 receives the reception signal, the controller 50 operates the vibration unit 40 according to the reception signal to generate vibration of a specific magnitude and a specific cycle. Accordingly, the user who grips the body 10 may identify an occurrence of an event in an augmented reality or a virtual reality or a success or a failure of attainment of a purpose or a target.

Further, the user may cause a change of an environment in an augmented reality or a virtual reality by moving the body 10 or performing a specific operation. That is, the user may move the body 10 vertically or horizontally or change the posture of the body 10, or may realize an operation, such as a linear motion, a parabolic motion, a circular motion, or a rotation. A specific transmission signal is generated according to a change of a location of the body 10, a change of a posture of the body 10, or an implementation of an operation of the body 10, and the transmission signal is delivered to the AR/VR device 200 though the communication unit 30 and acts as a command for performing a task in the augmented reality or the virtual reality. Further, a linear motion, a parabolic motion, a circular motion, or a rotation of the body 10 realized by the user may be detected and determined by the sensor unit 20 and the controller 50, and the vibration unit 40 may generate different vibrations according to the operations to allow the user to identify the operation realized by the user in a haptic way. Further, the user may determine whether an specific operation that is to be realized is properly realized and generate vibration for determining an implementation of the corresponding operation.

In this way, the present invention may cause a change of an environment in an augmented reality or a virtual reality in conjunction with the AR/VR device 200 and generate vibration according to a change of the environment in the augmented reality or the virtual reality or a change of a location of the body 10, a change of a posture of the body 10, or an implementation of an operation of the body 10 to allow the user to recognize the vibration through a haptic feeling, thereby doubling an immersion of the augmented reality or the virtual reality felt by the user.

The haptic device linked with an augmented reality or virtual reality implementation device according to the present invention is not limited to the above-mentioned embodiment, but may be variously modified and carried out without departing from the spirit of the present invention.

1. A haptic device linked with an augmented reality or virtual reality implementation device comprising:
a body that is gripped by a user;
a sensor unit installed in the body and configured to detect a location, a posture, or an operation of the body;
a communication unit installed in the body and configured to communicate with the augmented reality or virtual reality implementation device; and
a vibration unit installed in the body and configured to generate vibration in the body.

2. The haptic device of claim 1, wherein the communication unit receives a reception signal from the device according to a change of an environment in an augmented reality or a virtual reality realized by the device, and the vibration unit generates vibration in the body if receiving the reception signal.

3. The haptic device of claim 2, wherein the reception signal is any one of a plurality of different signals, and the vibration unit generates different vibrations, one or more of the magnitudes and cycles of which are different according to the reception signal.

4. The haptic device of claim 1, further comprising:
a controller installed in the body and configured to operate the communication unit and the vibration unit,
wherein the operation is stored in the controller in advance, the sensor unit detects a change of a location of the body or an implementation of the operation, and the communication unit delivers a transmission signal according to the change of the location of the body or the implementation of the operation to the device.

5. The haptic device of claim 4, wherein the environment in the augmented reality or the virtual reality changes according to the transmission signal delivered from the communication unit to the device, and the communication unit receives a reception signal from the device according to the change of the environment in the augmented reality or the virtual reality.

6. The haptic device of claim 4, wherein the operation is any one of a linear motion, a parabolic motion, a circular motion, and a rotation.

7. The haptic device of claim 6, wherein the vibration unit generates vibrations, one or more of magnitudes and cycles of which is different according to the operation.

8. The haptic device of claim 1, wherein the sensor unit includes any one of an acceleration sensor, a gyro sensor, and a geomagnetic sensor.
